(19) United States
(12) Patent Application Publication
(10) Pub. No.: US 2020/0342411 A1
(43) Pub. Date: Oct. 29, 2020

(54) PLATFORM FOR TRAINING AND TESTING USERS IN REALITY-BASED SIMULATED ENVIRONMENT

(71) Applicants: Oleg Yakubenkov, London (GB); Evgeniy Zhulkov, Moscow (RU)

(72) Inventors: Oleg Yakubenkov, London (GB); Evgeniy Zhulkov, Moscow (RU)

(21) Appl. No.: 16/394,673

(22) Filed: Apr. 25, 2019

(51) Int. Cl. G06Q 10/10; G06T 19/00; G09B 7/02; G06Q 10/06

(52) U.S. Cl. CPC G06Q 10/1053; G06Q 10/06398; G09B 7/02; G06T 19/003

(57) ABSTRACT

Platforms and methods for training and testing a user in a reality-based simulated environment are described herein. An example method may commence with receiving, via an administrative interface, a request to test the user. The request may include testing requirements. The method may continue with creating, based on the testing requirements, at least one scenario to test the user for at least one skill. The at least one scenario may include a plurality of consecutive tasks. The method may further include creating content for the plurality of consecutive tasks. The content may include real-life data, questions, and instructions for completing the plurality of consecutive tasks. The method may continue with providing, via the administrative interface, criteria for evaluating responses to the questions. The method may further include creating, via the administrative interface, a tree of possible task branches based on possible responses to the questions.

### TECHNICAL FIELD

The present disclosure relates generally to data processing and more particularly to a platform for training and testing users in a reality-based simulated environment.

### BACKGROUND

The approaches described in this section could be pursued but are not necessarily approaches that have previously been conceived or pursued. Therefore, unless otherwise indicated, it should not be assumed that any of the approaches described in this section qualify as prior art merely by virtue of their inclusion in this section.

Conventional online educational courses are usually based on online lectures, printed materials, and assignments. Even though the courses can be interesting to users, they are often ineffective in obtaining real skills, training the users with real data, and providing up-to-date hands-on experience to the users. Furthermore, the assignments may never get done by the users due to the lack of time or self-motivation and, hence, provide no real benefit to the users.

Additionally, conventional online educational courses often provide a set of information materials related to various topics in accordance with a predetermined order of information materials in a study plan. The level of understanding of the materials by a user is typically assessed by providing self-test questions to the user. However, such courses provide no detailed examination of understanding the materials and provide no additional materials on topics that the user finds difficult.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Provided are computer-implemented platforms and methods for training and testing a user in a reality-based simulated environment. In some example embodiments, a computer-implemented platform for training and testing a user in a reality-based simulated environment may include a data collection unit configured to receive, from a client via an administrative interface, a request to test the user. The request may include testing requirements. The platform may further include a processing unit configured to create, based on the testing requirements, via the administrative interface, at least one scenario to test the user for at least one skill. The at least one scenario may include a plurality of consecutive tasks. The platform may further include a content unit configured to create, via the administrative interface, content for the plurality of consecutive tasks. The content may include real-life data, questions, and instructions for completing the plurality of consecutive tasks. The platform may further include an analyzing unit configured to provide, via the administrative interface, criteria for evaluating responses to the questions. The analyzing unit may be further configured to create, via the administrative interface, a tree of possible task branches based on possible responses to the questions. The platform may further include a storage unit configured to store the at least one scenario, the plurality of consecutive tasks, and the responses.

A computer-implemented method for training and testing a user in a reality-based simulated environment may commence with receiving, from a client via an administrative interface, a request to test the user. The request may include testing requirements. The method may continue with creating, based on the testing requirements, via the administrative interface, at least one scenario to test the user for at least one skill. The at least one scenario may include a plurality of consecutive tasks. The method may further include creating, via the administrative interface, content for the plurality of consecutive tasks. The content may include real-life data, questions, and instructions for completing the plurality of consecutive tasks. The method may continue with providing, via the administrative interface, criteria for evaluating responses to the questions. The method may further include creating, via the administrative interface, a tree of possible task branches based on possible responses to the questions.

Additional objects, advantages, and novel features will be set forth in part in the detailed description section of this disclosure, which follows, and in part will become apparent to those skilled in the art upon examination of this specification and the accompanying drawings or may be learned by production or operation of the example embodiments. The objects and advantages of the concepts may be realized and attained by means of the methodologies, instrumentalities, and combinations particularly pointed out in the appended claims.

### BRIEF DESCRIPTION OF THE DRAWINGS

Embodiments are illustrated by way of example and not limitation in the figures of the accompanying drawings, in which like references indicate similar elements and in which:

FIG. 1 illustrates an environment within which platforms and methods for training and testing a user in a reality-based simulated environment can be implemented, in accordance with some embodiments.

FIG. 2 is a block diagram showing various modules of a platform for training and testing a user in a reality-based simulated environment, in accordance with certain embodiments.

FIG. 3 is a flow chart illustrating a method for training and testing a user in a reality-based simulated environment, in accordance with an example embodiment.

FIG. 4 is a schematic diagram illustrating training and testing a user in a reality-based simulated environment, according to an example embodiment.

FIG. 5 is a block diagram illustrating training a user using a platform for training and testing a user in a reality-based simulated environment, according to an example embodiment.

FIG. 6 shows a computing system that can be used to implement a method for training and testing a user in a reality-based simulated environment, according to an example embodiment.

### DETAILED DESCRIPTION

The following detailed description includes references to the accompanying drawings, which form a part of the detailed description. The drawings show illustrations in accordance with exemplary embodiments. These exemplary embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is, therefore, not to be taken in a limiting sense, and the scope is defined by the appended claims and their equivalents.

The present disclosure provides computer-implemented platforms and methods for training and testing users in a reality-based simulated environment. A platform for training and testing a user in a reality-based simulated environment is a data-driven platform for simulating working of the user in a real working environment. The platform provides a training course in which a reality-based working environment is simulated for the user and each next step of the training course is selected by the platform based on actions performed by the user on a previous step.

The platform may receive a request to test and/or train a user. The request may be sent by the user himself who wishes to undergo the training course or from a third-party client, such as an employer, an employment center, or an educational institution, which may want to train and/or test the user. The request may include testing requirements, such as selection of a training course, topics to study by the user, skills to develop by the user, a specialization to achieve by the user, and so forth.

Based on the testing requirements, the platform may create a scenario of the training course to train and test the user. Upon creation of the scenario, the platform may generate content for the training course based on the scenario. The content may include information materials, real-life data, questions, video materials, audio materials, instructions, and any other materials related to the scenario. In an example embodiment, the content may be generated by authors. The authors may include developers of the platform, third-party specialists, persons skilled in the topic of the scenario, and so forth. The authors may create the content for a specific topic, chapter, and story of the scenario.

The scenario may be divided into consecutive tasks. Each task may be provided to the user in a consecutive order and may include a portion of the content. The platform may select each next task to be provided to the user based on answers given by the user or activity performed by the user in a previous task. For example, the user may move through the scenario of the training course starting from a first task. The platform may also select criteria to evaluate responses to questions or actions of the user. Specifically, the platform may generate a tree of possible task branches based on possible responses to the questions. In particular, based on answers provided by the user in response to questions in the first task or based on an action performed by the user in the first task of the training course, the platform selects the next task of the scenario for the user. Therefore, the tasks are provided to the user not according to a predetermined linear order, but according to the selection of each consecutive task for the user based on the responses and/or actions of the user in the previous task.

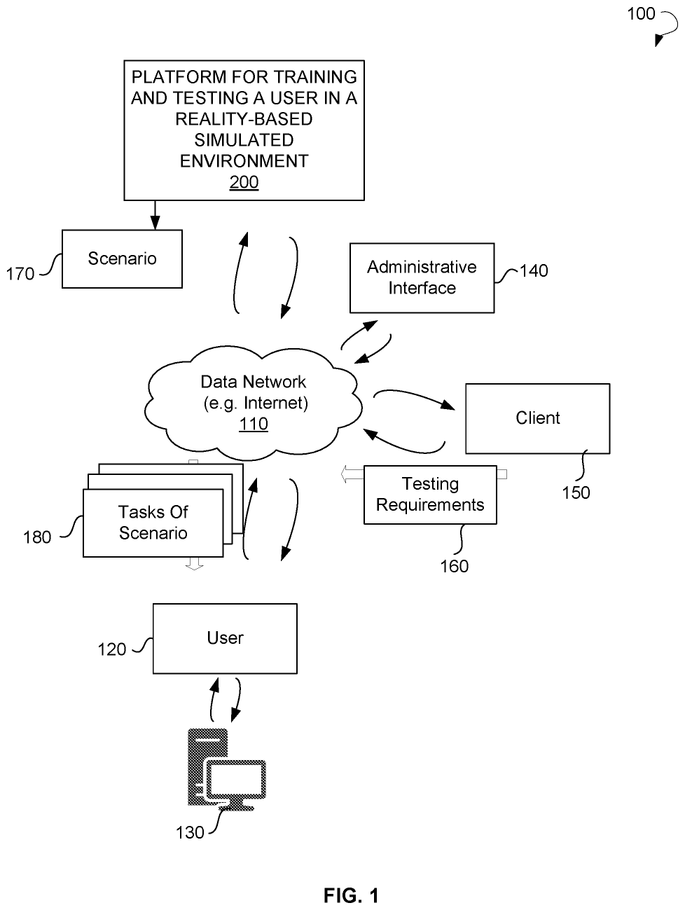

Referring now to the drawings, FIG. 1 illustrates an environment 100 within which methods and platforms for training and testing a user in a reality-based simulated environment can be implemented. The environment 100 may include a data network 110, a user 120, a user device 130 associated with the user 120, a platform 200 for training and testing a user in a reality-based simulated environment also referred to as a platform 200, an administrative interface 140 associated with the platform 200, and a client 150. The user device 130 may include a personal computer (PC), a laptop, a smartphone, a tablet PC, and so forth. The user 120, and client 150, and the platform 200 may be connected to the data network 110.

The data network 110 may include the Internet, a computing cloud, and any other network capable of communicating data between devices. Suitable networks may include or interface with any one or more of, for instance, a local intranet, a Personal Area Network, a Local Area Network, a Wide Area Network, a Metropolitan Area Network, a virtual private network, a storage area network, a frame relay connection, an Advanced Intelligent Network connection, a synchronous optical network connection, a digital T1, T3, E1 or E3 line, Digital Data Service connection, Digital Subscriber Line connection, an Ethernet connection, an Integrated Services Digital Network line, a dial-up port such as a V.90, V.34 or V.34bis analog modem connection, a cable modem, an Asynchronous Transfer Mode connection, or a Fiber Distributed Data Interface or Copper Distributed Data Interface connection. Furthermore, communications may also include links to any of a variety of wireless networks, including Wireless Application Protocol, General Packet Radio Service, Global System for Mobile Communication, Code Division Multiple Access or Time Division Multiple Access, cellular phone networks, Global Positioning System, cellular digital packet data, Research in Motion, Limited duplex paging network, Bluetooth radio, or an IEEE 802.11-based radio frequency network. The data network can further include or interface with any one or more of Recommended Standard 232 (RS-232) serial connection, an IEEE-1394 (FireWire) connection, a Fiber Channel connection, an IrDA (infrared) port, a Small Computer Systems Interface connection, a Universal Serial Bus connection or other wired or wireless, digital or analog interface or connection, mesh or Digi® networking. The data network may include a network of data processing nodes, also referred to as network nodes, that are interconnected for the purpose of data communication.

The platforms and methods described herein may also be practiced in a wide variety of network environments (represented by the data network 110) including, for example, Transmission Control Protocol/Internet Protocol-based networks, telecommunications networks, wireless networks, and the like. In addition, the computer program instructions may be stored in any type of computer-readable media.

The user 120 or the client 150 may send, via the administrative interface 140, a request to test the user 120 and testing requirements 160 to the platform 200. The platform 200 may receive the request and generate a scenario 170 of a training course for the user 120. The scenario 170 may consist of a plurality of tasks 180. The platform 200 may provide the tasks 180 of the scenario 170 to the user 120 to train and test the user 120.

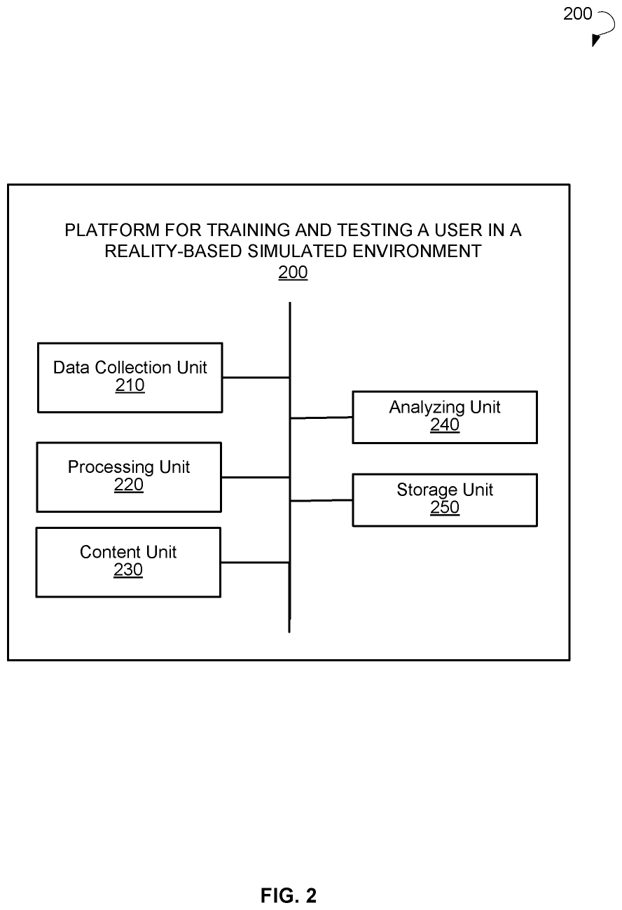

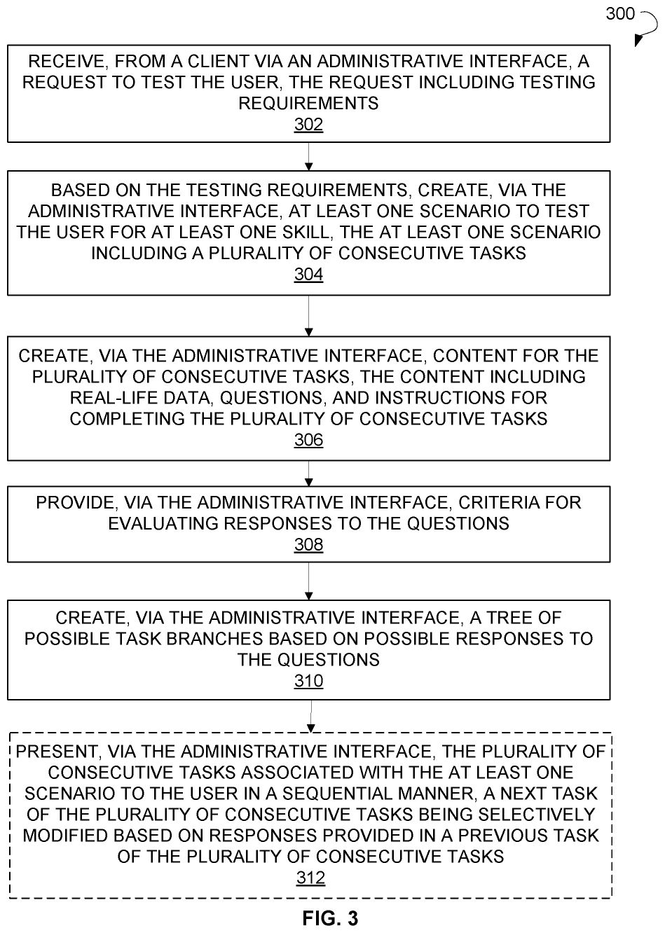

FIG. 2 is a block diagram showing various modules of a platform 200 for training and testing a user in a reality-based simulated environment, in accordance with certain embodiments. Specifically, the platform 200 may include a data collection unit 210, a processing unit 220, a content unit 230, an analyzing unit 240, and a storage unit 250. Each of the data collection unit 210, the processing unit 220, the content unit 230, the analyzing unit 240, and the storage unit 250 may include a programmable processor, such as a microcontroller, a central processing unit, and so forth. In example embodiments, each of the data collection unit 210, the processing unit 220, the content unit 230, the analyzing unit 240, and the storage unit 250 may include an application-specific integrated circuit or programmable logic array designed to implement the functions performed by the platform 200. Operations performed by each component of the platform 200 are described below with reference to FIG. 3.

FIG. 3 is a process flow diagram showing a method 300 for training and testing a user in a reality-based simulated environment, according to an example embodiment. In some embodiments, the operations may be combined, performed in parallel, or performed in a different order. The method 300 may also include additional or fewer operations than those illustrated. The method 300 may be performed by processing logic that may comprise hardware (e.g., decision making logic, dedicated logic, programmable logic, and microcode), software (such as software run on a general-purpose computer system or a dedicated machine), or a combination of both.

The method 300 may commence with receiving, by a data collection unit, a request to test a user at operation 302. The request may be received from a client via an administrative interface associated with the platform 200 shown on FIG. 2. In an example embodiment, the client may include the user himself when the user wants to undergo a training course. In another example embodiment, the client may include an employer requesting to test or train employees or job applicants, an employment center requesting to test or train prospective employees, an educational institution requesting to test or train students, and so forth. The request may include testing requirements. The testing requirements may include, for example, a position for which a user needs to be trained, skills to develop by the user, information materials to study by the user, tasks to be performed by the user, problems to be solved by the user, business decisions to be taken by the user to solve a problem, software products and online platforms to review and study by the user, and so forth. In an example embodiment, the request to test the user may include a request to evaluate the user for a perspective job. In a further example embodiment, the testing of the user may include evaluating results of a training course.

The method 300 may continue with operation 304, at which a processing unit may create, via the administrative interface, at least one scenario to test the user for at least one skill. The at least one scenario may be generated based on the testing requirements. The at least one scenario may include a plurality of consecutive tasks. The consecutive tasks may be directed to satisfying the testing requirements, i.e. to train the user for a certain job position in a company, develop skills by the user, provide information for the user to study, provide tasks to be performed by the user, present problems to be solved by the user, prompt the user to make decisions to solve a problem, and so forth. The training of the user may include providing the plurality of consecutive tasks of the created scenario to the user.

Furthermore, the reality-based simulated environment may be generated for the user based on the scenario. The reality-based simulated environment may be created by collecting real-case data related to the scenario from external sources or internal sources, such as a storage unit. The reality-based simulated environment can be generated for the user by simulating communication with characters (such as a team leader) in the scenario, providing study cases associated with real-world conditions and real-world situations characteristic for a job position, combining the communication with characters and the study cases into the scenario related to a particular job position or topic, providing real-life tools (e.g., software platforms, analytics platforms, computational platforms) for working on the scenario, and so forth. In addition, authors associated with the platform may develop study cases, collect or generate data and tasks associated with the study cases, develop a plurality of scenarios for a plurality of job positions, a plurality of skills to develop, and a plurality of results to achieve. The authors may include developers of the platform, third-party specialists, persons skilled in the topic of the scenario, persons occupying a job position related to the scenario, and so forth. All collected data and developed study materials can be provided to the processing unit. For example, in case the scenario includes training the user for a job position, the processing unit may collect data related to the job position or a similar job position from third-party companies. In particular, the processing unit may collect or generate historical data and statistical data related to the job position based on some predetermined criteria, use study cases developed by the authors based on the historical data and statistical data to train the user to work on the job position, use tasks created by the authors and related to the job position for the user based on the historical data and statistical data, and so forth. In other words, the processing unit may simulate real-world conditions and situations associated with the job position.

When undergoing the training course in the reality-based simulated environment, the user may perform the same tasks and the same activity as if the user works at the job position in a real company and, hence, may be dipped into a virtual workspace. For example, the user may interact with workers of the company (e.g., by receiving e-mails from a Chief Executive Officer (CEO) or a team lead of the company), pass through work situations that are likely to happen to the user in the same job position in a real company, work with real software programs and systems with which the user is likely to work in the job position, and so forth.

In an example embodiment, the method 300 may optionally include receiving user credentials by the data collection unit via a user interface. The data collection unit may establish a user identity based on the user credentials. In this embodiment, the processing unit may select the at least one scenario for the user based on the user identity.

The method 300 may further include creating, by a content unit, via the administrative interface, content for the plurality of consecutive tasks at operation 306. The content may include real-life data, questions, and instructions for completing the plurality of consecutive tasks for the user. In an example embodiment, the content may be generated by authors. The authors may include developers of the platform, third-party specialists, persons skilled in the topic of the scenario, and so forth. The authors may create the content for a specific topic, chapter, and story of the scenario.

The method 300 may continue with providing, by an analyzing unit via the administrative interface, criteria for evaluating responses to the questions at operation 308. At operation 310, the analyzing unit may create, via the administrative interface, a tree of possible task branches based on possible responses to the questions. The method 300 may further include presenting, by the content unit via the administrative interface, the plurality of consecutive tasks associated with the at least one scenario to the user in a sequential manner at operation 312. Each next task of the plurality of consecutive tasks may be selectively modified by the content unit based on responses provided by the user in a previous task of the plurality of consecutive tasks. The responses may include at least one of the following: making a business decision, an interaction with another employee, a solution to a problem, an acquisition of company information, a decision based on the acquired company information, and so forth. In an example embodiment, at least one task of the plurality of consecutive tasks may be displayed in a linear manner. For example, if the user provides a correct response to the task, a next task in the list of consecutive tasks of the scenario may be presented to the user. In an example embodiment, the modification of the task may include providing one or more further tasks related to a task for which the user provided an incorrect response. The modification of the task may further include providing one or more additional tasks related to a task for which the user provided a correct response.

The analyzing unit may evaluate responses of the user associated with each task based on predetermined criteria. Upon completion of all tasks, the analyzing unit may generate an aggregated score for the user. The analyzing unit may make the aggregated score available for the user. Furthermore, analyzing unit may make the aggregated score available for the client. The data collection unit may send the aggregated score of the user to one or more employers. In a further example embodiment, the analyzing unit may classify at least one task of the plurality of consecutive tasks into a plurality of skills. The analyzing unit may provide a separate score for each skill of the plurality of skills to the user or the client.

The processing unit may be further configured to compare the score of the user to a predetermined passing threshold. Based on the comparison, processing unit may selectively issue a digital certificate to the user, i.e. when the score is higher than the predetermined passing threshold.

The at least one scenario, the plurality of consecutive tasks, the responses, and any other data related to the user and the training may be stored in a storage unit of the platform 200 shown on FIG. 2.

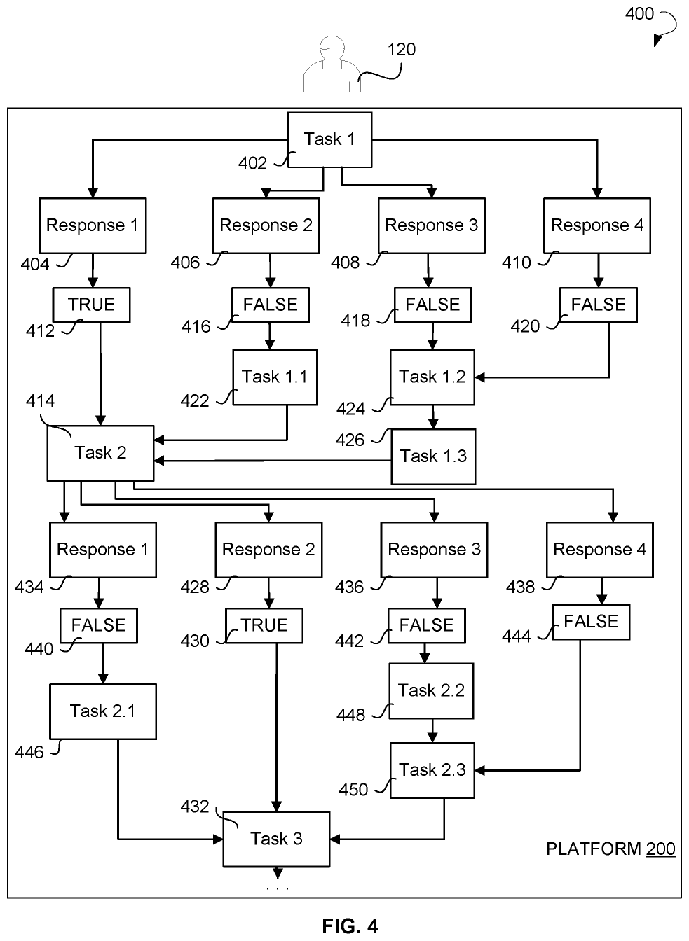

FIG. 4 is a block diagram 400 illustrating training and testing a user in a reality-based simulated environment, according to an example embodiment. The user may register in a training course, for example, by sending a request to the platform 200 shown on FIG. 2 using an administrative interface associated with the platform 200. Upon registering the user 120 in the training course, a scenario to test the user and a plurality of consecutive tasks of the scenario may be generated by the platform 200. A first task 402 may be presented to the user 120. The first task 402 may include a question, a problem to be solved by the user 120, information materials, and so forth. Several responses 404, 406, 408, and 410 may be provided to the user 120 for selection by the user 120 to solve the first task 402. The user 120 may select one of the response 404, 406, 408, and 410 considered by the user 120 to be a correct response. For example, the user 120 may review the first task 402 and select the first response 404 as the correct response for the first task 402. The platform 200 may receive the answer of the user 120 and determine, at step 412, that the selected first response 404 is the correct response. Upon determining that the user 120 selected the correct response, the platform 200 may present a second task 414 to the user 120.

In case the user 120 selects one of responses 406, 408, or 410 as the correct response for the first task 402, the platform 200 may determine that the selected response 406, 408, or 410 is an incorrect response, at step 416, 418, or 420, respectively. Upon determining that the user 120 selected the incorrect response, the platform 200 may present one or more additional tasks to the user 120, for example, an additional task 422 if the user 120 selected the response 406, and additional tasks 424 and 426 if the user selected the response 408. The additional tasks 422, 424, and 426 may include additional information materials to be studied by the user 120, questions, problems, and so forth. In an example embodiment, additional tasks for several incorrect responses may be the same. For example, in case the user 120 selects the response 410, the additional tasks 424 and 426 (the same as those used if the response 408 was selected) may be presented to the user 120. Upon completion of the additional tasks 422 or 424 and 426 by the user 120, the platform 200 may present the second task 414 to the user 120.

The user 120 may review the second task 414 and select a response 428 as the correct response for the second task 414. The platform 200 may receive the answer of the user 120 and determine, at step 430, that the selected response 428 is the correct response. Upon determining that the user 120 selected the correct response, the platform 200 may present a third task 432 to the user 120.

In case the user 120 selects one of responses 434, 436, or 438 as the correct response for the second task 414, the platform 200 may determine that the selected response 434, 436, or 438 is an incorrect response, at steps 440, 442, or 444, respectively. Upon determining that the user 120 selected the incorrect response, the platform 200 may present one or more additional tasks to the user 120, for example, an additional task 446 if the user 120 selected the response 434, and additional tasks 448 and 450 if the user selected the response 436. In an example embodiment, one or more of additional tasks for several incorrect responses may be the same. For example, in case the user 120 selects the response 438, the additional task 450 (the same as one of additional tasks used if the response 436 was selected) may be presented to the user 120. Upon completion of the additional tasks 446, 448, and 450 by the user 120, the platform 200 may present the third task 432 to the user 120. The process may continue until all tasks of the scenario of the training course are presented to the user 120 and solved by the user 120.

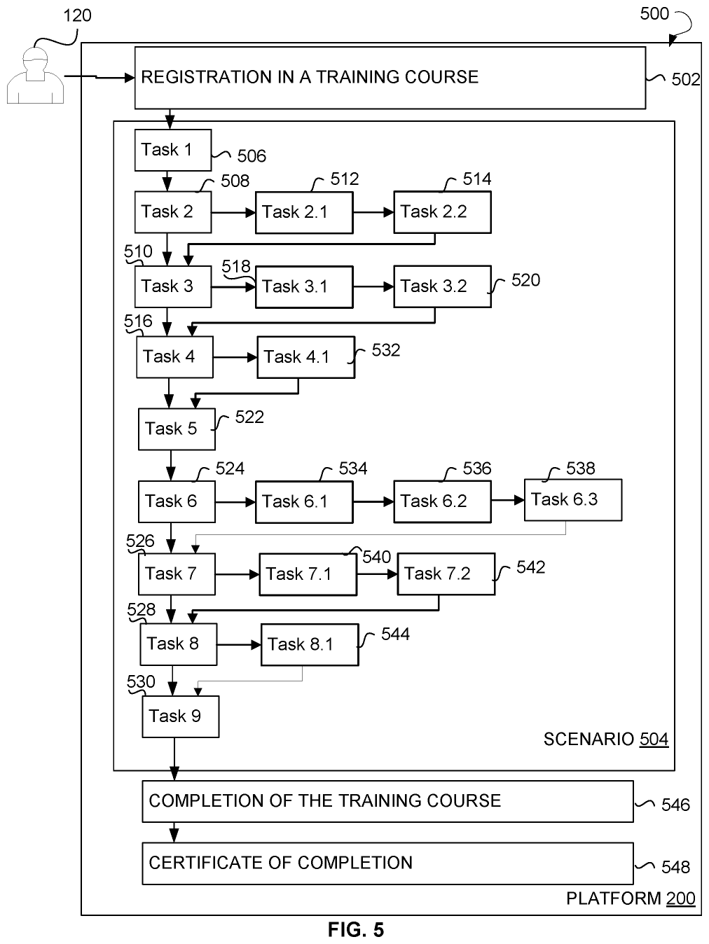

FIG. 5 is a block diagram 500 illustrating training a user using a platform for training and testing a user in a reality-based simulated environment, according to an example embodiment. The user 120 may register in a training course at step 502. The user 120 may provide testing requirements for the training course, such as personal data, user credentials, selection of a job position for which the user 120 wants to be trained, and so forth. The platform 200 may create a scenario 504 of the training course based on the testing requirements. The scenario 504 may include a plurality of consecutive tasks. A first task 506 may be presented to the user 120. Upon responding to the first task 506 by the user 120, a second task 508 may be presented to the user 120. If the user 120 responds to the second task 508 correctly, a third task 510 may be presented to the user 120. If the user 120 selects an incorrect response to the second task 508, additional tasks 512 and 514 may be presented to the user 120. Upon solving the additional tasks 512 and 514 by the user 120, the third task 510 may be presented to the user 120.

Similarly, upon providing the response to the third task 510 by the user 120, either a fourth task 516 (if the user 120 responded correctly) or additional tasks 518 and 520 (if the user 120 responded incorrectly) may be presented to the user 120. Upon responding to the additional tasks 518 and 520 by the user 120, the fourth task 516 may be presented to the user 120.

In a similar manner, tasks 522, 524, 526, 528, and 530 are consecutively presented to the user 120 if the user 120 responds correctly to each preceding task. Furthermore, an additional task 532 (related to task 516), additional tasks 534, 536 and 538 (related to task 524), additional tasks 540 and 542 (related to task 526), and an additional task 544 (related to task 528) may be presented to the user 120 if the user responds incorrectly to the tasks 516, 522, 524, 526, and 528.

Upon completion of all tasks of the scenario 504 by the user 120, the training course may be completed at step 546. At step 548, a certificate of completion of the training course may be issued and provided to the user 120.

In various example embodiments, the scenario 504 may be directed to one of the following: product management, product analytics, marketing, product marketing, product development, software programming, software testing, human resource management, public relations, technical writing, brand management, business analysis, and so forth.

### Example: A Data-Driven Product Management Training Course

The platform 200 shown on FIG. 2 may act as a technological platform based on which a user can be trained to manage a production of a digital product or a physical product. The platform 200 may enable to dip the user into a simulated environment that is close to conditions and situations that exist in reality. In case of the product management training course, the user may be trained on how to use the data for the product development. Upon starting the training course, the user may become a part of a simulated company, may pass an interview to the simulated company, get a job, communicate with other characters of the simulated company, perform tasks, work in an analytics system where data are simulated, and so forth. In other words, the platform may help to submerge the user into the simulated environment which is close to a real startup company environment or an existing company environment. The whole scenario of working conditions from start to finish may be developed for the user by the platform. The user may start with the interview in the company and may be moved to situations when the company has problems and achievements. The user may work on a simulated virtual product that evolves in the course of time. The data provided to the user for working may be simulated based on historical data related to some real virtual products. The data may reflect the events that occur within the framework of the scenario. For example, in case an update of the simulated product is performed, the data may correctly show how users switch to the new version, how the behavior of users changes, and how the situations happen over time.

The structure of the training course may be a linear structure according to which the user may receive a task and complete the task. The tasks may be built based on the text, pictures, audio, video, and so forth. Based on a response provided by the user to the task, the user may go through different branches in the scenario of the training course. In the process of passing the tasks of the scenario, the user may communicate (e.g., in writing) with other characters of the scenario (i.e., emulated persons occupying various job positions in the emulated company) and pass through real-life-based situations that are likely to happen to the user in a real company. The user may work with real software systems, e.g., the user may use analytics systems which the user is likely to work in the position of the product manager in a real company.

In an example embodiment, the training course may be not a course based on real cases of existing company, but may be a scenario invented specifically for the user. In the training course, the user may make business decisions, interact with other characters of the scenario, solve problems and, as part of this process, learn materials and gain skills needed for this particular job position.

In an example embodiment, when the user begins to pass the training course, the user may meet a first character, such as a CEO of the emulated company in which the user is trying to get a position of the product manager. After an interview with the CEO, the user may move to the next step. The user may be asked some questions. The user may select the answer to the questions and click ‘Next’ button to pass to the next step of the scenario. Depending on the answer of the user, a user moves along a branched tree of tasks in the scenario. The scenario may be generated according to the answers given by the user. In an example embodiment, the scenario may be created for each product individually to enable the user to study the complete development process for the product. The scenario may consist of structured blocks, which may expand linearly or with branches. Specifically, in some cases, the scenario may have a linear structure, but some tasks may have branches of tasks. The responses of the user can be right or wrong. After receiving the response from the user, the correct response and the explanation of the correct response with some education materials may be presented to the user. If the user answers incorrectly, additional tasks related to the topic of the main task may be presented to the user so that the user can learn additional information and gain additional skills in association with the topic the user does not know. Accordingly, the user may move along the branched tree of tasks in the scenario and solve tasks. Upon solving the tasks, the user may receive theoretical content personalized based on answers of the user, which may help the user structure experience and knowledge of the user. The user may apply the information studied in the training course and skills achieved in the training course directly in the tasks of the training course.

In an example embodiment, the user may climb the carrier ladder in a simulated software startup company, e.g., by starting the training course as a data analyst and moving to other job positions up to a CEO of the software startup company.

In an example embodiment, the platform may assess the progress of the user in the training course and determine an aggregated score for the user. In some embodiments, the platform may assess specific skills or knowledge of the user, e.g., a mathematical apparatus, the theory of probability, work with an analytics system. The platform may provide a separate score for each skill of the user.

Moreover, statistics of responses of the user may be collected for each question. In some embodiments, a specific question may not be taken into consideration when calculating a total score for the certificate. When the user completes the training course, the certificate where the percentage of correct answers is indicated may be generated and provided to the user.

The platform may be in communication with a plurality of companies. The user may apply for a job position, e.g., a product manager, in the companies by sending results of the training course (e.g., by sending a score or a certificate of completion of the training course) to the companies. In some embodiments, a company may send a request to train the user using the platform. In this case, the training course may be an internship of the user at the position of the product manager in the company.

Upon completion of a specific task or a complete training course, the user may be requested to provide a feedback and recommendations with respect to the training course, and/or review the training course.

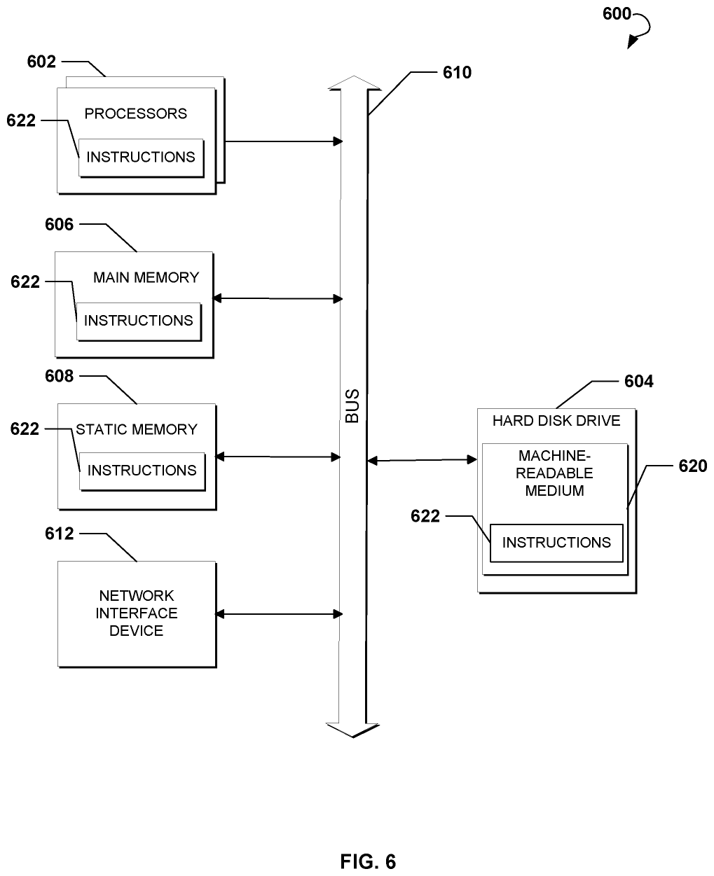

FIG. 6 shows a diagrammatic representation of a computing device for a machine in the exemplary electronic form of a computer system 600, within which a set of instructions for causing the machine to perform any one or more of the methodologies discussed herein can be executed. In various exemplary embodiments, the machine operates as a standalone device or can be connected (e.g., networked) to other machines. In a networked deployment, the machine can operate in the capacity of a server or a client machine in a server-client network environment, or as a peer machine in a peer-to-peer (or distributed) network environment. The machine can be a PC, a tablet PC, a set-top box, a cellular telephone, a digital camera, a portable music player (e.g., a portable hard drive audio device, such as an Moving Picture Experts Group Audio Layer 3 (MP3) player), a web appliance, a network router, a switch, a bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 600 may include a processor or multiple processors 602, a hard disk drive 604, a main memory 606 and a static memory 608, which communicate with each other via a bus 610. The computer system 600 may also include a network interface device 612. The hard disk drive 604 may include a computer-readable medium 620, which stores one or more sets of instructions 622 embodying or utilized by any one or more of the methodologies or functions described herein. The instructions 622 can also reside, completely or at least partially, within the main memory 606 and/or within the processors 602 during execution thereof by the computer system 600. The main memory 606 and the processors 602 also constitute machine-readable media.

While the computer-readable medium 620 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media. Such media can also include, without limitation, hard disks, floppy disks, NAND or NOR flash memory, digital video disks, Random Access Memory, Read-Only Memory, and the like.

The example embodiments described herein may be implemented in an operating environment comprising software installed on a computer, in hardware, or in a combination of software and hardware.

In some embodiments, the computer system 600 may be implemented as a cloud-based computing environment, such as a virtual machine operating within a computing cloud. In other embodiments, the computer system 600 may itself include a cloud-based computing environment, where the functionalities of the computer system 600 are executed in a distributed fashion. Thus, the computer system 600, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud may be formed, for example, by a network of web servers that comprise a plurality of computing devices, such as the computer system 600, with each server (or at least a plurality thereof) providing processor and/or storage resources. These servers may manage workloads provided by multiple users (e.g., cloud resource customers or other users). Typically, each user places workload demands upon the cloud that vary in real-time, sometimes dramatically. The nature and extent of these variations typically depends on the type of business associated with the user.

Thus, platforms and methods for training and testing a user in a reality-based simulated environment are described. Although embodiments have been described with reference to specific exemplary embodiments, it will be evident that various modifications and changes can be made to these exemplary embodiments without departing from the broader spirit and scope of the present application. Accordingly, the specification and drawings are to be regarded in an illustrative rather than a restrictive sense.

1. A computer-implemented platform for providing training and testing content to a user in a reality-based simulated environment, the platform comprising:
a data collection unit configured to receive, from a client via an administrative interface, a request to test the user, the request including testing requirements;
a processing unit configured to:
create, based on the testing requirements, via the administrative interface, at least one scenario to test the user for at least one skill, the at least one scenario including a plurality of consecutive tasks; and
select, from content, each of the plurality of consecutive tasks associated with the at least one scenario for presenting to the user, wherein the selection of each of the plurality of consecutive tasks includes:
evaluating a response provided by the user to a previous task of the plurality of consecutive tasks;
when the response provided by the user to the previous task is correct, selecting a next task of the plurality of consecutive tasks from tasks that linearly depend on the previous task in a tree; and
when the response provided by the user to the previous task is incorrect, selecting the next task of the plurality of consecutive tasks from tasks in a task branch associated with the previous task in the tree, wherein the previous task and the tasks in the task branch relate to an identical topic;
a content unit configured to:
create, via the administrative interface, the content for the plurality of consecutive tasks, the content including real-life data, questions, and instructions for completing the plurality of consecutive tasks; and
present, via the administrative interface, each of the plurality of consecutive tasks associated with the at least one scenario to the user according to the tree; and
an analyzing unit configured to:
provide, via the administrative interface, criteria for evaluating responses to the questions; and
create, via the administrative interface, the tree of possible task branches based on possible responses to the questions; and
a storage unit configured to store the at least one scenario, the plurality of consecutive tasks, and the responses.

2. The platform of claim 1, wherein the data collection unit is further configured to:
receive user credentials via a user interface;
establish a user identity based on the user credentials;
wherein the processing unit is further configured to:
select the at least one scenario based on the user identity;
wherein
the next task of the plurality of consecutive tasks is selectively modified based on responses provided in the previous task of the plurality of consecutive tasks; and
wherein the analyzing unit is further configured to:
evaluate responses associated with each task based on predetermined criteria;
generate an aggregated score for the user; and
make the aggregated score available for the client.

3. The platform of claim 2, wherein the modification includes one or more of the following: providing one or more further tasks related to a task for which the user provided an incorrect response and providing one or more additional tasks related to a task for which the user provided a correct response.

4. The platform of claim 1, wherein the testing the user includes evaluating the user for a perspective job.

5. The platform of claim 1, wherein the testing the user includes evaluating results of a training.

6. The platform of claim 1, wherein the analyzing unit is further configured to:
classify at least one task of the plurality of consecutive tasks into a plurality of skills; and
provide a separate score for each skill of the plurality of skills.

7. The platform of claim 1, wherein at least one task of the plurality of consecutive tasks is displayed in a linear manner.

8. The platform of claim 1, wherein the responses include at least one of the following: making a business decision, an interaction with another employee, a solution to a problem, an acquisition of company information, and a decision based on the acquired company information.

9. The platform of claim 1, wherein the processing unit is further configured to:
comparing the score to a predetermined passing threshold; and
based on the comparison, selectively issuing a digital certificate to the user.

10. The platform of claim 2, wherein the data collection unit is further configured to send the aggregated score of the user to one or more employers.

11. The platform of claim 1, wherein the client includes one of the following: the user, an employer, an employment center, and an educational institution.

12. A computer-implemented method for providing training and testing content to a user in a reality-based simulated environment, the method comprising:
receiving, from a client via an administrative interface, a request to test the user, the request including testing requirements;
based on the testing requirements, creating, via the administrative interface, at least one scenario to test the user for at least one skill, the at least one scenario including a plurality of consecutive tasks;
creating, via the administrative interface, content for the plurality of consecutive tasks, the content including real-life data, questions, and instructions for completing the plurality of consecutive tasks;
providing, via the administrative interface, criteria for evaluating responses to the questions;
creating, via the administrative interface, a tree of possible task branches based on possible responses to the questions;
selecting, from the content, each of the plurality of consecutive tasks associated with the at least one scenario for presenting to the user, wherein the selecting of each of the plurality of consecutive tasks includes:
evaluating a response provided by the user to a previous task of the plurality of consecutive tasks;
when the response provided by the user to the previous task is correct, selecting a next task of the plurality of consecutive tasks from tasks that linearly depend on the previous task in the tree; and
when the response provided by the user to the previous task is incorrect, selecting the next task of the plurality of consecutive tasks from tasks in a task branch associated with the previous task in the tree, wherein the previous task and the tasks in the task branch relate to an identical topic; and
presenting, via the administrative interface, each of the plurality of consecutive tasks associated with the at least one scenario to the user according to the tree.

13. The method of claim 12, further comprising:
receiving user credentials via a user interface;
establishing a user identity based on the user credentials;
selecting the at least one scenario based on the user identity;
wherein the next task of the plurality of consecutive tasks is selectively modified based on responses provided in the previous task of the plurality of consecutive tasks;
evaluating responses associated with each task based on predetermined criteria;
generating an aggregated score for the user; and
making the aggregated score available for the client.

14. The method of claim 12, wherein the reality-based simulated environment is generated for the user by one or more of the following: simulating communication with characters in the at least one scenario, providing tools for working in the at least one scenario, providing study cases associated with real-world conditions and real-world situations characteristic for a job position, and combining the communication with characters and the study cases into the at least one scenario.

15. The method of claim 12, wherein the testing the user includes evaluating the user for a perspective job.

16. The method of claim 12, wherein the testing the user includes evaluating results of a training.

17. The method of claim 12, further comprising:
classifying at least one task of the plurality of consecutive tasks into a plurality of skills; and
providing a separate score for each skill of the plurality of skills.

18. The method of claim 12, wherein the responses include at least one of the following: making a business decision, an interaction with another employee, a solution to a problem, an acquisition of company information, and a decision based on the acquired company information.

19. The method of claim 12, further comprising:
comparing the score to a predetermined passing threshold; and
based on the comparison, selectively issuing a digital certificate to the user.

20. A computer-implemented platform for providing training and content to testing a user in a reality-based simulated environment, the platform comprising:
a data collection unit configured to:
receive, from a client via an administrative interface, a request to test the user, the request including testing requirements;
receive user credentials via a user interface; and
establish a user identity based on the user credentials;
a processing unit configured to:
based on the testing requirements, create, via the administrative interface, at least one scenario to test the user for at least one skill, the at least one scenario including a plurality of consecutive tasks, wherein the at least one scenario is directed to one of the following: product management, product analytics, marketing, product marketing, product development, software programming, software testing, human resource management, public relations, technical writing, brand management, and business analysis;
select the at least one scenario based on the user identity; and
select, from content, each of the plurality of consecutive tasks associated with the at least one scenario for presenting to the user, wherein the selection of each of the plurality of consecutive tasks includes:
evaluating a response provided by the user to a previous task of the plurality of consecutive tasks;
when the response provided by the user to the previous task is correct, selecting a next task of the plurality of consecutive tasks from tasks that linearly depend on the previous task in a tree; and
when the response provided by the user to the previous task is incorrect, selecting the next task of the plurality of consecutive tasks from tasks in a task branch associated with the previous task in the tree, wherein the previous task and the tasks in the task branch relate to an identical topic; and
a content unit configured to:
create, via the administrative interface, the content for the plurality of consecutive tasks, the content including real-life data, questions, and instructions for completing the plurality of consecutive tasks; and
present, via the administrative interface, each of the plurality of consecutive tasks associated with the at least one scenario to the user according to the tree, the next task of the plurality of consecutive tasks being selectively modified based on responses provided in the previous task of the plurality of consecutive tasks;
an analyzing unit configured to:
provide, via the administrative interface, criteria for evaluating responses to the questions;
create, via the administrative interface, the tree of possible task branches based on possible responses to the questions;
evaluate responses associated with each task based on predetermined criteria;
generate an aggregated score for the user; and
make the aggregated score available for the client; and
a storage unit configured to store the at least one scenario, the plurality of consecutive tasks, and the responses.
